(19) United States
(12) Patent Application Publication
(10) Pub. No.: US 2017/0267163 A1
(43) Pub. Date: Sep. 21, 2017

(54) VEHICLE DECORATIVE LIGHTING DEVICE AND VEHICLE LAMP

(71) Applicant: Stanley Electric Co., Ltd., Tokyo (JP)

(72) Inventor: Naoki Watanabe, Tokyo (JP)

(21) Appl. No.: 15/442,483

(22) Filed: Feb. 24, 2017

(30) Foreign Application Priority Data
Mar. 16, 2016 (JP) 2016-052570

(51) Int. Cl. B60Q 1/24; B60Q 1/44; F21S 8/10

(52) U.S. Cl. CPC B60Q 1/24; F21S 48/1241; F21S 48/1317; B60Q 1/44; F21S 48/2225; F21S 48/234; F21S 48/1225; F21S 48/115; F21S 48/215; F21Y 2115/10

(57) ABSTRACT

A vehicle decorative lighting device and a vehicle lamp including the lighting device includes a light guide formed in a nearly ring shape and a pair of light sources that can emit various color lights. Each of the light sources can be located at a respective one of incident surfaces of a lighting body including the light guide. The vehicle lamp can include a lamp room between an outer lens and a casing, and can incorporate various vehicle lamps such as a headlight along with the lighting device in the lamp room. The lighting device can be located in the lamp room so as to emit various color lights while surrounding a vehicle lamp. Thus, the disclosed subject matter can include providing vehicle lamps including the decorative lighting device having a harmonious favorable light distribution, for example, such that combine a headlight with a position lamp with a thin structure.

This application claims the priority benefit under 35 U.S.C. §119 of Japanese Patent Application No. 2016-052570 filed on Mar. 16, 2016, which is hereby incorporated in its entirety by reference.

### BACKGROUND

1. Field

The presently disclosed subject matter relates to vehicle decorative lighting devices and vehicle lamps including the decorative lighting device, and more particularly to vehicle decorative lighting devices having a high visibility and a favorable light distribution, which can be incorporated into a central portion of the vehicle lamp. Thus, the vehicle lamp that includes the decorative lighting device or devices can have a high visual quality with a compact size, which can emit harmonious light with respect to other lighting devices or lamps, and which can be used as a position lamp when the vehicle lamps are used as a headlight.

2. Description of the Related Art

Various vehicle lamps, including decorative lighting devices that form secondary light distributions, are known as a vehicle lamp, including headlights, tail lamps, etc. For example, a conventional vehicle lamp including a decorative lighting device is disclosed in Patent Document No. 1 (U.S. Pat. No. 8,870,423), which is owned by Applicant of this disclosed subject matter. FIG. 7 is a perspective view showing a conventional vehicle lamp including a vehicle decorative lighting device, which is disclosed in Patent Document No. 1.

The vehicle lamp 70 incorporates, for example, a vehicle headlight 74 along with a vehicle decorative lighting device 75 in a lamp room thereof, which may be attached to a front and left portion of a vehicle. Another vehicle headlight attached to a front and right portion of the vehicle can be symmetrical to the vehicle headlight 70.

The vehicle lamp 70 includes: a housing 72 having an opening 72a in a light-emitting direction of the vehicle lamp 70, and the opening 72a inclining from a right (a middle direction of a vehicle) toward a left (a side direction of a vehicle) in an upper right direction from a front view of the vehicle lamp 70 and inclining in a rear direction of the vehicle lamp 70 from a side view of the vehicle lamp 70; an outer lens (not shown in FIG. 7) covering the opening 72a of the housing 72; a lamp room located between the outer lens and the housing 72; a headlight unit 74 located in the lamp room so as to emit light in the light-emitting direction of the vehicle lamp 70 via the outer lens; and also the decorative lighting device 75 located in the lamp room and along a periphery of the opening 72a of the housing 72 so as to emit light via the outer lens.

FIG. 8A is a schematic front view showing the conventional decorative lighting device shown in FIG. 7. The vehicle decorative lighting device 75 includes a light guide lens having a first end surface 75a and a second end surface 75b, which is formed in a substantially slender U-shape, and a pair of light sources 76 located at the first and second end surfaces 75a and 75b so that each of lighting-emitting surfaces of the light sources 76 faces a respective one of the first and second end surfaces 75a and 75b.

As each of the pair of light sources 76, an LED (light-emitting diode) light source such as a white LED light source, a yellow LED light source, an amber LED light source, a red LED light source and the like is used depending on the intended use of the decorative lighting device 75. For example, semiconductor light-emitting devices that may emit various color lights as disclosed in Patent Document No. 2 (U.S. Pat. No. 8,461,610), which is owned by Applicant of this disclosed subject matter, may be used as the LED light source.

The light guide lens includes: a first linear portion 75U having the first end surface 75a located at a top portion of the light guide lens and linearly extending in an extending direction of the light guide lens (the extending direction being relative to the light guide lens itself and therefore extending along a longitudinal axis thereof at any given specific location thereof); a second linear portion 75L having the second end surface 75b located at a bottom portion of the light guide lens and linearly extending in the extending direction of the light guide lens; a first curved portion 75R1 having a first curvature radius R1 at a central axis thereof continuously connecting to the first linear portion 75U and extending toward the second linear portion 75L; a second curved portion 75R2 having a second curvature radius R2 at a central axis thereof continuously connecting to the second linear portion 75L and extending toward the first curved portion 75R1; and a third linear portion 75S linearly extending in the extending direction of the light guide lens, and continuously connected between the first curved portion 75R1 and the second curved portion 75R2 so as to extend in a top and bottom direction of the light guide lens.

FIG. 8B is an explanatory drawing depicting a light ray trajectory in the light guide lens of the vehicle decorative lighting device with respect to light emitted from the light sources 76. The light emitted from the light sources 76 enters into the light guide lens from each of the first and second end surfaces 75a and 75, and moves in the extending direction X of the light guide lens while it repeats internal reflections in the light guide lens. In this case, the light emitted from the light sources 76 is reflected by the prism faces 75P, which are arranged in the extending direction X, and is emitted from the front surface of the light guide lens and over the entire length of the light guide lens.

Thereby, the light guide lens, which is located along the periphery of the opening 72a of the housing 72 as shown in FIG. 7, provides a light distribution as the vehicle decorative lighting device 75 via the outer lens from the front surface of the light guide lens, which is the light-emitting surface of the vehicle decorative lighting device 75. Consequently, the decorative lighting device 75 may provide a favorable light distribution having a high visibility and a high visual quality, and also may be formed in various curved shapes such that they fit various vehicle lamps and is attached to front and/or rear corners of a vehicle.

However, because vehicular designs become more multifaceted, various vehicle lamps including the decorative lighting device are required to fit each of the vehicular designs. For example, there is a compelling need for vehicle decorative lighting devices formed in a nearly ring shape such that surround the headlight 74 shown in FIG. 7. Hence, a conventional vehicular light guide to emit a light-emitting distribution pattern formed in a ring shape is disclosed in Patent Document No. 3 (Japanese Patent Application Laid Open No. 2006-85,908).

FIG. 9 is a cross-sectional structural view showing the conventional vehicular light guide to emit the light-emitting distribution pattern formed in the ring shape, which is disclosed in Patent Document No. 3. The conventional vehicular light guide 80 includes: an incident portion 81 having an incident surface 81a formed in a cylindrical shape; a first light guide 82 having a first reflex surface 82a extending from the incident portion 81 in a substantially tubular shape, and the first reflex surface 82a located in an outward direction of the first light guide 82; a second light guide 83 extending from the first light guide 82 in a substantially tubular shape; and a third light guide 84 having a third reflex surface 84a extending from the second light guide 83 in a substantially tubular shape, and the third reflex surface 84a located in an outward direction of the third light guide 84.

In addition, the conventional vehicular light guide 80 also includes: a light-emitting portion 85 having a light-emitting surface 85a extending from the third light guide 84 in a tubular shape, the light-emitting surface 85 located on a top surface of the light-emitting portion 85 in an opposite direction of the third light guide 84; and an LED light source 90 located so as to face the incident surface 81a of the incident portion 81. Hence, the conventional light guide 80 may emit the light-emitting distribution pattern formed in the ring shape from the light-emitting surface 85a, which is formed in the tubular shape by using light emitted from the LED light source 90.

However, the conventional vehicular light guide 80 includes the first light guide 82, the second light guide 83 and the third light guide 84 to transmit the light emitted from the light source 90 toward the light-emitting surface 85a, and therefore may become long in a light-emitting direction thereof. Additionally, it may be difficult for the vehicle light guide 80 to accomplish a vehicle lamp formed in a nearly ring shape such that surround the headlight 74 shown in FIG. 7 as described above.

The above-referenced Patent Documents and additional Patent Documents are listed below and are hereby incorporated with their English specifications and abstracts in their entireties.

1. Patent Document No. 1: U.S. Pat. No. 8,870,423

2. Patent Document No. 2: U.S. Pat. No. 8,461,610

3. Patent Document No. 3: Japanese Patent Application Laid Open No. 2006-85,908

4. Patent Document No. 4: U.S. Pat. No. 8,860,047

5. Patent Document No. 5: U.S. Pat. No. 8,864,353

6. Patent Document No. 6: U.S. Pat. No. 7,976,203

The disclosed subject matter has been devised to consider the above and other problems, characteristics and features. Thus, exemplary embodiments of the disclosed subject matter can include vehicle decorative lighting devices which can provide a favorable light distribution having a high visibility and a high visual quality with a thin structure, and which can emit harmonious light with respect to other lighting devices or lamps.

In addition, exemplary embodiments of the disclosed subject matter can include vehicle decorative lighting devices which can emit various color lights using an LED light source having a low power consumption such that the lighting devices can be incorporated into various vehicle lamps such as a headlight, a turn signal lamp, a stop lamp, etc. In this case, when the vehicle lamp is a headlight such that a white LED light source or an HID bulb is used as a light source, the vehicle decorative lighting device can emit a harmonious white light with light emitted from the headlight so as to be usable as a position lamp and the like. Also, when the vehicle lamp is configured as a stop lamp such that a red LED light source is used as a light source, the vehicle decorative lighting device can emit a harmonious red light with light emitted from the stop lamp so as to be usable as a tail lamp, etc.

### SUMMARY

The presently disclosed subject matter has been devised in view of the above and other characteristics, desires, and problems in the conventional art. An aspect of the disclosed subject matter can include vehicle decorative lighting devices, which can be formed in a nearly ring shape with a thin structure, and which can provide a favorable light distribution having a high visibility and a high visual quality. Another aspect of the disclosed subject matter can include providing vehicle lamps including the decorative lighting devices, which can easily incorporate a headlight for a low beam and/or a high beam into the decorative lighting device because the decorative lighting device can have the nearly ring shape with the thin structure. The vehicle decorative lighting devices and vehicle lamps can also emit a harmonious light with respect to light emitted from other components of the vehicle decorative lighting devices and lamps.

According to one aspect of the disclosed subject matter, a vehicle decorative lighting device can include: an opening section; and a lighting body having a pair of incident portions and a light guide made from a transparent resin, each of the incident portions having an incident surface and an inclined surface located in an opposite direction of the incident surface formed in a substantially planar shape, the light guide formed in a substantially planar shape, the opening section located between each of the incident portions, thereby the light guide formed in a nearly ring shape having the opening section on a ring shape, each of the inclined surfaces continuously connecting to a respective one of end surfaces of the light guide and inclined at a prescribed degree angle in a direction of a rear surface of light guide with respect to the respective one of the end surfaces, a principal light guide portion of the light guide including a front surface and an inner surface of the light guide, and extending along the inner surface between the respective of the end surfaces of light guide, the front surface of the light guide formed in a diffusing shape, a subsidiary light guide portion of the light guide continuously connecting to the principal light portion, extending along the principal light guide portion between the respective of the end surfaces of light guide, and expanding from the principal light guide portion toward the rear surface of the light guide, and therefore the rear surface located between the inner surface and the subsidiary light guide portion of the light guide and between the respective one of the end surfaces of light guide, and including a concave prism surface formed in a plurality of concave prism shapes, the concave prism shapes aligned at a predetermined concave interval in a longitudinal direction of the light guide and extend in a wide direction of the light guide.

In addition, the vehicle decorative lighting device can also include: a reflector having a reflective surface, the reflective surface thereof facing the rear surface of light guide; and a pair of light sources each having a light-emitting surface, each of the light-emitting surfaces facing a respective one of the incident surfaces of the incident portions, and wherein each of the incident portions extends from the respective one of the end surfaces of light guide toward each of the light-emitting surfaces of the light sources.

In the above-described exemplary vehicle lighting devices, the diffusing shape of the light guide can include at least one of a fisheye lens surface and a flute lens surface as a diffusing surface. The prescribed degree angle of each of the inclined surfaces with respect to the respective one of the end surfaces of the light guide can be set at a larger angle than an optimum angle with reference to the inclined surfaces, and an angle between the inner surface and the top surface of the light guide can be 90 degrees or less to efficiently enter light emitted from the light sources into the light guide. Additionally, the rear surface of the light guide can include a concave shape, and also the reflective surface of the reflector can include a concave shape to efficiently use leaked lights from the light guide. Similarly, the lighting device can further include a convex lens surface on the reflective surface of the reflector.

According to the above-described exemplary vehicle decorative lighting devices, while the light emitted from the light sources that can emit various color lights moves smoothly in the light guide formed in the nearly ring shape with a thin structure, the light can be reflected by the rear surface including the concave prism surface toward the front surface and can be emitted from the front surface of the light guide lens. Thus, the disclosed subject matter can provide vehicle decorative lighting devices, which can be formed in the nearly ring shape with a thin structure, and which can provide a favorable light distribution having a high visibility and a high visual quality.

According to another aspect of the disclosed subject matter, an exemplary vehicle lamp including the vehicle decorative lighting device can include: a housing having an opening; an outer lens formed from a transparent material and attached to the opening of the casing; a lamp room formed between the casing and the outer lens; a headlight arranged in the lamp room; and the vehicle decorative lighting device arranged in the lamp room so as to surround the headlight, the front surface of the light guide of the vehicle decorative lighting device facing the outer lens, wherein the vehicle decorative lighting device is used as a position lamp.

According to another aspect of the disclosed subject matter, the exemplary vehicle lamps can incorporate various vehicle lamps such as a headlight, a stop lamp and the like into the vehicle decorative lighting device, which can easily incorporate the headlight for a low beam and/or a high beam into the decorative lighting device because the decorative lighting device can have the nearly ring shape with the thin structure, and which can emit various color lights including a substantially white color light. Thus, the disclosed subject matter can also provide vehicle lamps including the vehicle decorative lighting devices, which can easily incorporate a low beam headlight, a high beam headlight and the like into the decorative lighting device, and which can also emit a harmonious light with light emitted from the vehicle decorative lighting device.

### BRIEF DESCRIPTION OF THE DRAWINGS

These and other characteristics and features of the disclosed subject matter will become clear from the following description with reference to the accompanying drawings, wherein:

FIG. 1 is a front view showing an exemplary embodiment of a vehicle decorative lighting device made in accordance with principles of the disclosed subject matter;

FIG. 2 is an exploded perspective view showing the embodiment of the vehicle decorative lighting device shown in FIG. 1;

FIG. 3A is a partial cross-sectional view taken along Line A-A shown in FIG. 1 depicting an exemplary locating relation of a light source, a light body and a reflector of the vehicle decorative lighting device, FIG. 3B is a partial cross-sectional view taken along Line B-B shown in FIG. 1 depicting an exemplary locating relation of the light body and the reflector of the vehicle decorative lighting device, and FIG. 3C is a partial enlarged view of Circle C shown in FIG. 3A depicting a light guide of the light body;

FIGS. 4A and 4B are explanatory drawings depicting light ray trajectories in the vehicle decorative lighting devices shown in FIG. 3A and FIG. 1, respectively;

FIG. 5 is an explanatory drawing showing an exemplary embodiment of a vehicle lamp using the vehicle decorative lighting device shown in FIG. 1;

FIGS. 6A and 6B is front views showing the exemplary embodiment and an exemplary variation of the light guide of the vehicle decorative lighting device, respectively;

FIG. 7 is a perspective view showing a conventional vehicle lamp including a vehicle decorative lighting device;

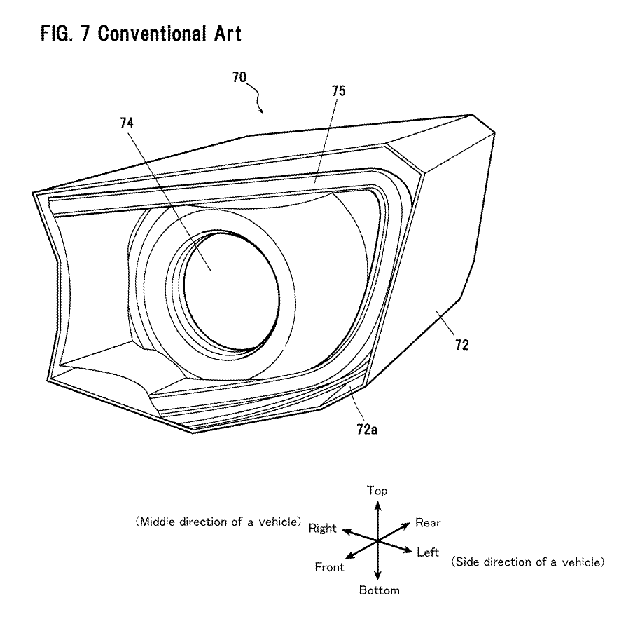

FIG. 8A is a schematic front view showing the vehicle decorative lighting device shown in FIG. 7, and FIG. 8B is an explanatory drawing depicting a light ray trajectory in a light guide lens of the vehicle decorative lighting device shown in FIG. 8A; and

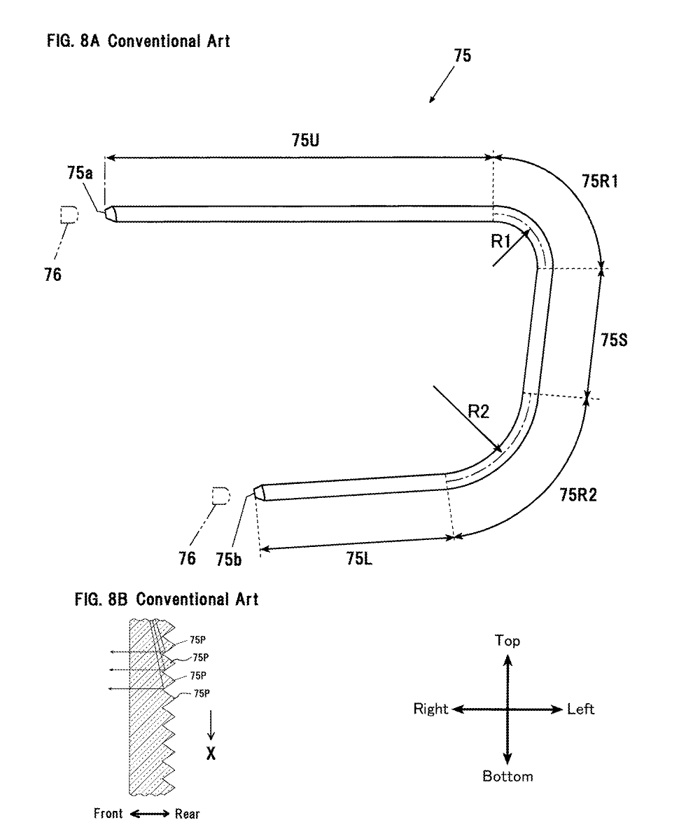

FIG. 9 is a cross-sectional structural view showing a conventional vehicular light guide.

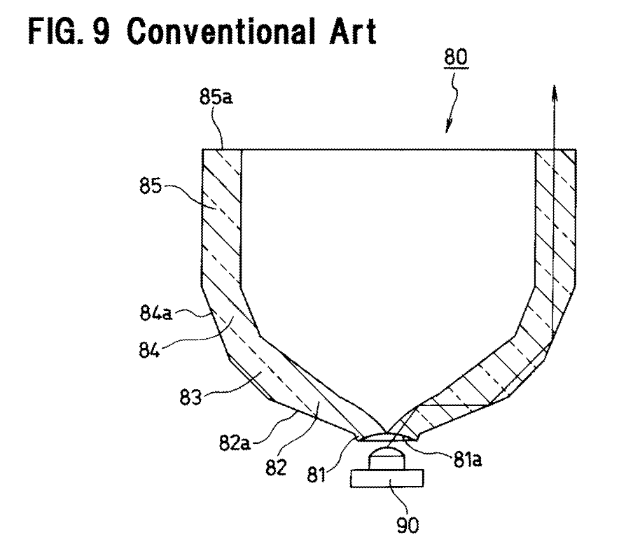

### DETAILED DESCRIPTION OF EXEMPLARY EMBODIMENTS

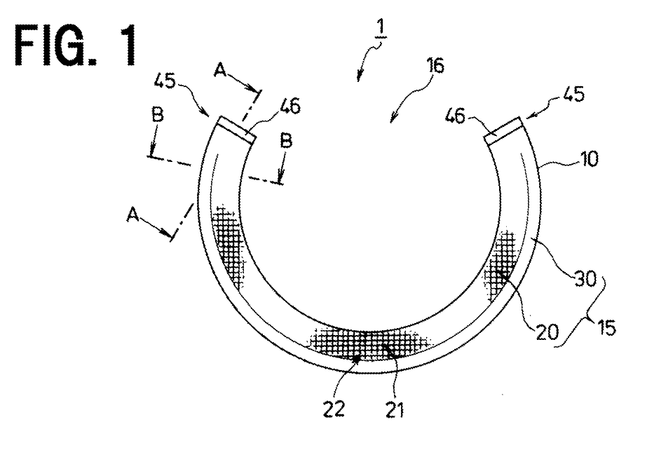

The disclosed subject matter will now be described in detail with reference to FIG. 1 to FIG. 6B, in which the same, similar, or corresponding elements use the same reference marks. FIG. 1 is a front view showing an exemplary embodiment of a vehicle decorative lighting device made in accordance with principles of the disclosed subject matter. The vehicle decorative lighting device 1 can include a lighting body 10 having a pair of bending portions 45 and a light guide 15, the light guide 15 having a principal light guide portion 20 and a subsidiary light guide portion 30 continuously connecting each of the bending portions 45 and formed in a roughly ring planar shape in the front view, and the principal light guide portion 20 including a fisheye lens surface 22, which is formed in a plurality of fish-eye lenses 21, and each of bending portions 45 including an inclined surface 46.

In addition, the vehicle decorative lighting device 1 can also include an opening section 16 located between each of the bending portions 45 of the lighting body 10. Accordingly, the vehicle decorative lighting device 1 can be formed in a nearly ring shape because the light guide 15 of the lighting body 10 may be formed in a nearly ring shape having the opening section on a ring shape while including the opening section 16 between each of the bending portions 45.

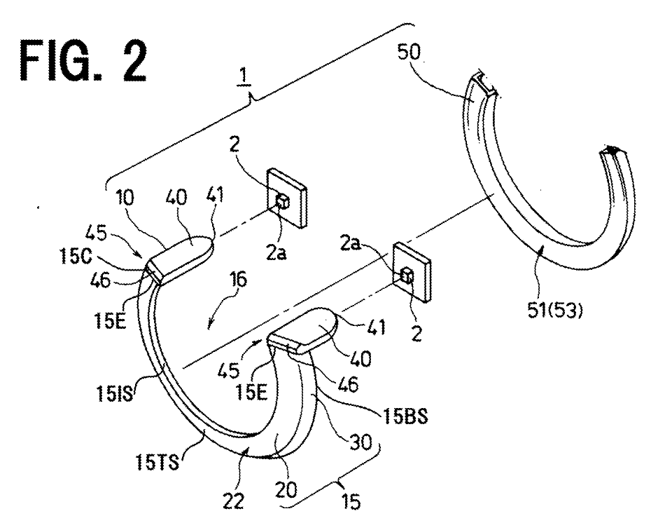

An exemplary specific structure of the vehicle decorative lighting device 1 will now be described with reference to FIG. 2, which is an exploded perspective view showing the embodiment of the vehicle decorative lighting device shown in FIG. 1. Each of the pair of bending portions 45 of the lighting body 10 can include an incident portion 40 having an incident surface 41 and the inclined surface 46 formed in a substantially planar shape, extending in a direction substantially perpendicular to the light guide 15 and continuously connected to an end surface 15E of the light guide 15, and the incident surface 41 located in an opposite direction of the inclined surface 46.

Accordingly, the lighting body 10 can be continuously connected between the end surface 15E of the light guide 15 and the inclined surface 46 of the incident portion 40, which is inclined at a prescribed degree angle with respect to the end surface 15E of the light guide 15. The lighting body 10 can be composed a transparent resin such as an acrylic resin, a polycarbonate resin, a polyester resin, a polyolefin resin and the like. A connecting portion, which is between the end surface 15E of the light guide 15 and the inclined surface 46 of the incident portion 40, can be formed in the same plain surface as the light guide 15 and also can be formed in a substantially round shape, because the incident portion 40 including the inclined surface 46 is generally integrated in the lighting body 10 along with the light guide 15.

The principal light guide portion 20 of the light guide 15, which is formed in a substantially planar shape, can extend along an inner surface 15IS of the light guide 15 and can be formed in the nearly ring shape. The subsidiary light guide portion 30 can extend along the principal light guide portion 20 and can be located in an opposite direction the inner surface 15IS of the light guide 15. Additionally, the subsidiary light guide portion 30 can be continuously connected to the principal light guide portion 20 and can incline so as to expand from a front surface 15TS of the light guide 15 toward a rear surface 15BS of the light guide 15. On the front surface 15TS of the light guide 15, the fisheye lens surface 22 can be formed as a diffusing surface as described above with reference to FIG. 1

The vehicle decorative lighting device 1 can also include: a reflector 50 having a reflective surface 51 made from a convex lens surface 53, and the reflective surface 51 facing the guide rear surface 15BS of the light guide 15; and a pair of light sources 2 having a light-emitting surface 2a facing a respective one of the incident surfaces 41 of the incident portions 40 of the light body 10. Accordingly, when lights emitted from the light sources 2 leak from the light body 10, the leaked light can return into the light body 10 including the light guide 15 and the incident portions 40. The respective one of the incident surface 41 can be formed in a convex shape and also can be formed in a substantially plain shape. Additionally, the respective one of the incident surface 41 can be also formed in a substantially concave shape if each of the lights emitted from the light sources 2 may be received by the respective one of the incident surface 41 of the lighting body 10.

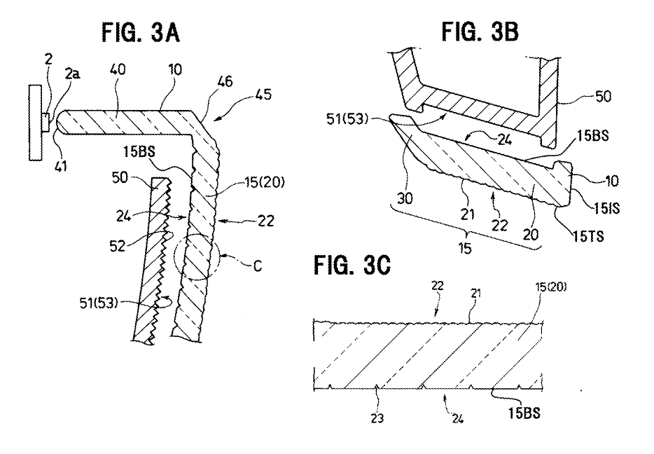

FIG. 3A is a partial cross-sectional view taken along Line A-A shown in FIG. 1 depicting an exemplary locating relation of the light source 2, the light body 10 and the reflector 50 of the vehicle decorative lighting device 1, FIG. 3B is a partial cross-sectional view taken along Line B-B shown in FIG. 1 depicting an exemplary locating relation of the light body 20 and the reflector 50 of the vehicle decorative lighting device 1, and FIG. 3C is a partial enlarged view of Circle C shown in FIG. 3A depicting the light guide 15 of the light body 20. The principal light guide portion 20 of the light guide 15 can include the fisheye lens surface 22 formed in the plurality of fish-eye lenses 21 as described above.

In addition, on the rear surface 15BS of the light guide 15, a concave prism surface 24 formed in a plurality of concave prism shapes 23, which are aligned at a predetermined concave interval in a longitudinal direction of the light guide 15 of the light body 20 and extend in a wide direction of the light guide 15, can be formed. The convex lens surface 52 formed in a plurality of convex lens shapes 53 (e.g., triangular prism) on the reflective surface 51 of the reflector 50 can also be aligned at a predetermined convex interval in the longitudinal direction of the light guide 15 of the light body 20 and can extend in the wide direction of the light guide 15.

In this case, each of the predetermined convex intervals between the adjacent convex lens shapes 53 of the reflector 50 in the longitudinal direction of the light guide 15 of the light body 20 can be shorter than each of the predetermined concave intervals between the adjacent concave prism shapes 23 formed on the rear surface 15BS of the light guide 15 so as to improve a reflectance of the reflective surface 51 of the reflector 50. Additionally, the reflective surface 51 can also be formed by a metallic plate such as an aluminum layer and the like instead of the convex lens surface 53 formed on the reflective surface 51 of the reflector 50.

Moreover, the reflective surface 51 of the reflector 50, which includes the convex lens surface formed in a plurality of convex lens shapes 53 thereon, can include a concave shape in the wide direction of the light guide 15, and also the rear surface 15BT of the light guide 15, which includes the concave prism surface 24 formed in the plurality of the concave prism shapes 23, can include a concave shape toward the front surface 15TS of the light guide 15 in the wide direction of the light guide 15 as shown in FIG. 3B. An angle between the inner surface 15IS of light guide 50 and the top surface 15BT of the light guide 15 can be 90 degrees or less. Thereby, leaked lights from the light guide 15 toward the reflector 50 can be efficiently returned into the light guide 15.

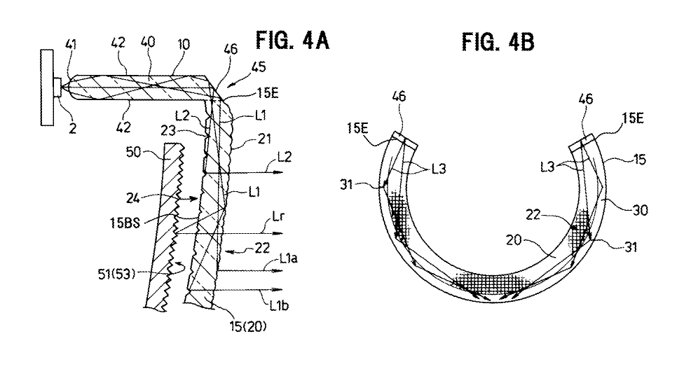

Next, exemplary light ray trajectories in the vehicle decorative lighting devices 1 will now be described with reference to FIG. 4A corresponding to FIG. 3A and FIG. 4B corresponding to FIG. 1. The light emitted from the light source 2 can be entered into the incident portion 40 of the lighting body 10 from the incident surface 41, and can be directed toward the inclined surface 46 of the incident portion 40 while a part of the light emitted from the light source 2 reflects on an outside surface 42 of the incident portion 40. The light reached on the inclined surface 46 can be directed toward the light guide 15 of the lighting body 20 because the inclined surface 46 of the incident portion 40 is inclined at the prescribed degree angle with respect to the end surface 15E of the light guide 15.

In this case, the prescribed degree angle of the inclined surface 46 can be set up at a larger angle than an optimum angle with reference to the inclined surface 46, and therefore said light reflected by the inclined surface 46 of the incident portion 40 can be directed toward the light guide 15 in a high efficient manner. Accordingly, each of the lights emitted from the light sources 2 can be nearly evenly entered into the light guide 15 of the lighting body 20 from a respective of the inclined surface 46 via a respective one of the inclined surfaces 46,

One light L1 of the lights can be reached to the fisheye lens surface 22, which is formed on the front surface 15TS (of the principal light guide portion 20) of the light guide 15, and another light L2 of the lights can be reached to the concave prism surface 24, which is formed on the rear surface 15BS of the light guide 15. The other light L3 of them can be directed toward the subsidiary light guide portion 30 of the light guide 15 as shown in FIG. 4B.

In the one light L1 reached to the fisheye lens surface 22 of the principal light guide portion 20 of the light guide 15, a part light L1a of the one light L1 can be emitted in a light-emitting direction of the vehicle decorative lighting device 1 as diffusing lights because of the plurality of fish-eye lenses 21. Another light L1b of the one light L1, which is returned into the light guide 15 by reflecting the one light L1 on the fisheye lens surface 22 of the principal light guide portion 20, can also be emitted in the light-emitting direction of the vehicle decorative lighting device 1 as diffusing lights because of the plurality of fish-eye lenses 21 by reflecting the one light L1 on the concave prism surface 24 of the rear surface 15BS of the light guide 15, after repeating the reflection between the concave prism surface 24 and the fish-eyes lens surface 22 according to circumstances.

In another light L2 reached to the concave prism surface 24 of the rear surface 15BS of the light guide 15, a part light of another light L2 can be emitted in the light-emitting direction of the vehicle decorative lighting device 1 as diffusing lights because of the plurality of fish-eye lenses 21. Another light, which is returned into the light guide 15 by reflecting the light L2 on the fisheye lens surface 22 of the principal light guide portion 20, can also be emitted in the light-emitting direction of the vehicle decorative lighting device 1 as diffusing lights because of the plurality of fish-eye lenses 21 by reflecting the light L2 on the concave prism surface 24 of the rear surface 15BS of the light guide 15 in common with the one light L1.

In addition, lights Lr, which are leaked from the rear surface 15BS of the light guide 15 in the lights L1 and L2 described above, can return into the light guide 15 because the lights Lr are reflected by the convex lens surface 53 formed on the reflective surface 51 of the reflector 50. Accordingly, the lights Lr can also be emitted in the light-emitting direction of the vehicle decorative lighting device 1 as diffusing lights finally because of the plurality of fish-eye lenses 21 in the same manner as the lights L1 and L2 as described above.

The other light L3, which is directed toward the subsidiary light guide portion 30 of the light guide 15, can be returned in a direction of the rear surface 15BS by the subsidiary light guide portion 30, which expands from the principal light guide portion 20 toward the rear surface 15BS of the light guide 15. Consequently, the other light L3 can also be emitted in the light-emitting direction of the vehicle decorative lighting device 1 as diffusing lights finally because of the plurality of fish-eye lenses 21 in the same manner as the lights L1, L2 and Lr.

Each of the lights emitted from the light sources 2 may decrease a light-emitting intensity thereof as each of path lengths of the lights becomes long. However, each of light having a high emitting-intensity and light having a low emitting-intensity in the lights emitted from the light sources 2 can be mixed in an appropriate manner between the end surfaces 15E of the light guide 15 in near portions of the end surfaces 15E. In far portions of the end surfaces 15, each of lights having a relatively low emitting-intensity in the lights emitted from the light sources 2 can be mixed in an appropriate manner between the end surfaces 15E of the light guide 15. Therefore, the vehicle decorative lighting device 1 of the disclosed subject matter can emit light having a substantially uniform emitting-intensity.

As each of the pair of light sources 2, an LED (light-emitting diode) light source such as a white LED light source, a yellow LED light source, an amber LED light source, a red LED light source and the like can be used depending on the intended use of the decorative lighting device 1. For example, semiconductor light-emitting devices that can emit various color lights including a substantially white color tone as disclosed in Patent Document No. 4 (U.S. Pat. No. 8,860,047) can be used as the LED light source.

The LED light source can emit light having a high light-intensity with a low power consumption, and also can be provided with a light-emitting surface having various shapes that match each shape of the incident surfaces 41 of the lighting body 10. Accordingly, when an optical axis of the LED light source corresponds to each center of the incident surfaces 41, light emitted from the LED light source can enter into the light guide 15 via the incident portion 40 with a higher efficiency. Therefore, the disclosed subject matter can provide vehicle decorative lighting devices having a high visibility and a favorable light distribution, which can be incorporated into a central portion of a vehicle lamp.

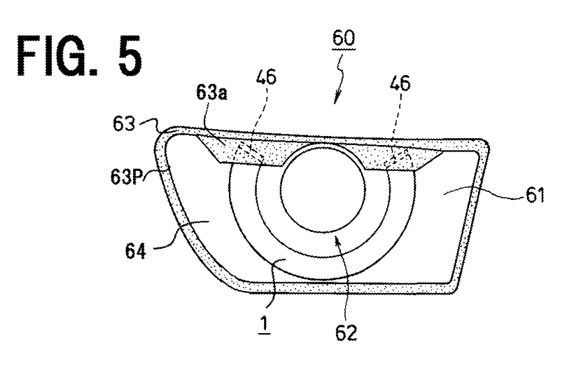

An exemplary embodiment of the vehicle lamp using the vehicle decorative lighting device 1 will now be described with reference to FIG. 5. When the vehicle lamp 60 is used as a front combination lamp, the vehicle lamp 60 can include: a casing 63 having an opening 63P including a decorative panel 63; an outer lens 64 formed from a transparent material such as a polycarbonate resin, and attached to the opening 63P of the casing 60; a lamp room 61 formed between the casing 63 and the outer lens 64; a headlight 62 arranged in the lamp room 61; and the vehicle decorative lighting device 1 arranged in the lamp room 61 so as to surround the headlight 62.

Thereby, the vehicle decorative lighting device 1 can be arranged in the nearly ring shape so as to surround the headlight 62, which is formed in a circular shape, while the connecting portion between the end surface 15E of the light guide 15 and the inclined surface 46 of the incident portion 40 is covered with the decorative panel 63 of the casing 63. Additionally, the decorative lighting device 1 can various color lights including substantially white light having a substantially uniform light-intensity.

Thus, when the headlight 62 is used as a white light source such as a white LED light source, an HID bulb and the like, the vehicle decorative lighting device 1 can emit a harmonious white light with light emitted from the headlight so as to be usable as a position lamp and the like. Also, when the lamp (62) is configured as a stop lamp such that a red LED light source is used as a light source, the vehicle decorative lighting device 1 can emit a harmonious red light with light emitted from the stop lamp so as to be usable as a tail lamp, etc.

In addition, the vehicle lamp 60 can incorporate at least one of various vehicle lamps such as a low beam headlight, a high beam headlight, a turn signal lamp and the like using various light sources such as an HID bulb, a white LED light source, a halogen bulb, etc. as disclosed in Patent Document No. 5 (U.S. Pat. No. 8,864,353), along with the vehicle decorative lighting device 1. The vehicle lamp 60 can also incorporate at least one of vehicle signal lamps such as a tail lamp, a stop lamp and the like, as disclosed in Patent Document No. 6 (U.S. Pat. No. 7,976,203), along with the vehicle decorative lighting device 1.

For example, when the vehicle lamp 60 includes a stop lamp such that a red LED light source is used as a light source, the vehicle decorative lighting device 1 can emit a harmonious red light with light emitted from the stop lamp so as to be able to use as a tail lamp by using a red LED light source as the light sources 2. Therefore, the vehicle lamp 60 including the stop lamp and the vehicle decorative lighting device 1 can provide a harmonious favorable light distribution having a high visibility and a high visual quality with a thin structure

According to the exemplary vehicle lamps, the exemplary vehicle lamps can incorporate various vehicle lamps such as a headlight and the like along with the vehicle decorative lighting device, which can various color lights using the LED light sources. Thus, the disclosed subject matter can also provide vehicle lamps including the vehicle decorative lighting devices, which can easily incorporate various vehicle lamps such as a low beam headlight, a high beam headlight and the like along with the decorative lighting device, and which can also emit a harmonious light with light emitted from the vehicle decorative lighting device.

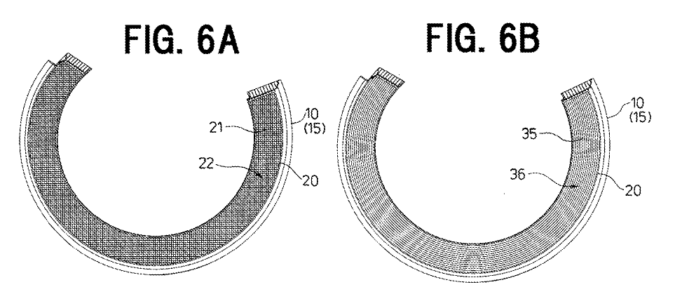

Various modifications of the above disclosed embodiments can be made without departing from the spirit and scope of the presently disclosed subject matter. For example, cases where the light guide 15 of the vehicle decorative lighting device 1 is formed in the fish-eye lens surface 20 on the front surface 15TS thereof as a diffusing shape are described as shown in FIG. 6A. However, the light guide 10 is not limited to this diffusing shape and can be formed in various shapes such as a flute lens surface 36 formed in a plurality of flute lenses 35 as shown in FIG. 6B. In addition, the specific arrangement between components can vary between different applications, and several of the above-described features can be used interchangeably between various embodiments depending on a particular application of the device.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entireties by reference.

What is claimed is:

1. A vehicle decorative lighting device, comprising:
an opening section;
a lighting body having a pair of incident portions and a light guide made from a transparent resin, each of the incident portions having an incident surface and an inclined surface formed in a substantially planar shape, and the inclined surface located in an opposite direction of the incident surface, the light guide having a pair of end surfaces, a principal light guide portion, a subsidiary light guide portion, an inner surface, a front surface and a rear surface formed in a substantially planar shape, the opening section located between each of the incident portions, thereby the light guide formed in a nearly ring shape having the opening section on a ring shape, each of the inclined surfaces continuously connecting to a respective one of the end surfaces of the light guide and inclined at a prescribed degree angle in a direction of the rear surface of light guide with respect to the respective one of the end surfaces, the principal light guide portion including the front surface and the inner surface of the light guide and extending along the inner surface in the nearly ring shape between the respective of the end surfaces of light guide, the front surface of the light guide formed in a diffusing shape, the subsidiary light guide portion continuously connecting to the principal light portion, extending along the principal light guide portion between the respective of the end surfaces of light guide, and expanding from the principal light guide portion toward the rear surface of the light guide, and therefore the rear surface located between the inner surface and the subsidiary light guide portion of the light guide and between the respective one of the end surfaces of light guide, and including a concave prism surface formed in a plurality of concave prism shapes, the concave prism shapes aligned at a predetermined concave interval in a longitudinal direction of the light guide and extend in a wide direction of the light guide;
a reflector having a reflective surface, and the reflective surface of the reflector facing the rear surface of light guide; and
a pair of light sources each having a light-emitting surface, each of the light-emitting surfaces of the light sources facing a respective one of the incident surfaces of the incident portions of lighting body, and wherein each of the incident portions of lighting body extends from the respective one of the end surfaces of light guide toward each of the light-emitting surfaces of the light sources.

2. The vehicle decorative lighting device according to claim 1, wherein the diffusing shape of the front surface of the light guide includes at least one of a fish-eye lens surface formed in a plurality of fish-eye lenses and a flute lens surface formed in a plurality of convex lenses that extend along the inner surface of the light guide and are aligned in the wide direction of the light guide.

3. The vehicle decorative lighting device according to claim 1, wherein the prescribed degree angle of each of the inclined surfaces with respect to the respective one of the end surfaces of the light guide is set at a larger angle than an optimum angle with reference to the inclined surfaces.

4. The vehicle decorative lighting device according to claim 1, wherein an angle between the inner surface of light guide and the top surface of the light guide is 90 degrees or less.

5. The vehicle decorative lighting device according to claim 1, further comprising:
a convex lens surface formed in a plurality of convex lens shapes on the reflective surface of the reflector, the convex lens shapes aligned at a predetermined convex interval in the longitudinal direction of the light guide and extending in the wide direction of the light guide.

6. The vehicle decorative lighting device according to claim 2, further comprising:
a convex lens surface formed in a plurality of convex lens shapes on the reflective surface of the reflector, the convex lens shapes aligned at a predetermined convex interval in the longitudinal direction of the light guide and extending in the wide direction of the light guide.

7. The vehicle decorative lighting device according to claim 5, wherein the predetermined convex interval of the convex lens shapes of the reflector is shorter than the predetermined concave interval of the concave prism shapes formed on the rear surface of the light guide.

8. The vehicle decorative lighting device according to claim 6, wherein the predetermined convex interval of the convex lens shapes of the reflector is shorter than the predetermined concave interval of the concave prism shapes formed on the rear surface of the light guide.

9. The vehicle decorative lighting device according to claim 1, wherein the rear surface of the light guide includes a concave shape toward the front surface of the light guide.

10. The vehicle decorative lighting device according to claim 1, wherein the reflective surface of the reflector includes a concave shape.

11. A vehicle lamp including the vehicle decorative lighting device according to claim 1, comprising:
a casing having an opening;
an outer lens formed from a transparent material and attached to the opening of the casing;
a lamp room formed between the casing and the outer lens;
a headlight arranged in the lamp room; and
the vehicle decorative lighting device arranged in the lamp room so as to surround the headlight, the front surface of the light guide of the vehicle decorative lighting device facing the outer lens, wherein the vehicle decorative lighting device is used as a position lamp.

12. A vehicle lamp including the vehicle decorative lighting device according to claim 1, comprising:
a casing having an opening;
an outer lens formed from a transparent material and attached to the opening of the casing;
a lamp room formed between the casing and the outer lens;
a stop lamp arranged in the lamp room; and
the vehicle decorative lighting device arranged in the lamp room so as to surround the stop lamp, the front surface of the light guide of the vehicle decorative lighting device facing the outer lens, wherein the vehicle decorative lighting device is used as a tail lamp.

13. The vehicle lamp according to claim 11, wherein the diffusing shape of the front surface of the light guide of the vehicle decorative lighting device includes at least one of a fish-eye lens surface formed in a plurality of fish-eye lenses and a flute lens surface formed in a plurality of convex lenses that extend along the inner surface of the light guide and are aligned in the wide direction of the light guide.

14. The vehicle lamp according to claim 11, wherein the prescribed degree angle of each of the inclined surfaces of the vehicle decorative lighting device with respect to the respective one of the end surfaces of the light guide is set at a larger angle than an optimum angle with reference to the inclined surfaces.

15. The vehicle lamp according to claim 11, wherein an angle between the inner surface of light guide and the top surface of the light guide of the vehicle decorative lighting device is 90 degrees or less.

16. The vehicle lamp according to claim 11, further comprising:
a convex lens surface formed in a plurality of convex lens shapes on the reflective surface of the reflector of the vehicle decorative lighting device, the convex lens shapes aligned at a predetermined convex interval in the longitudinal direction of the light guide and extending in the wide direction of the light guide.

17. The vehicle lamp according to claim 13, further comprising:
a convex lens surface formed in a plurality of convex lens shapes on the reflective surface of the reflector of the vehicle decorative lighting device, the convex lens shapes aligned at a predetermined convex interval in the longitudinal direction of the light guide and extending in the wide direction of the light guide.

18. The vehicle lamp according to claim 16, wherein the predetermined convex interval of the convex lens shapes of the reflector is shorter than the predetermined concave interval of the concave prism shapes formed on the rear surface of the light guide.

19. The vehicle lamp according to claim 17, wherein the predetermined convex interval of the convex lens shapes of the reflector is shorter than the predetermined concave interval of the concave prism shapes formed on the rear surface of the light guide.

20. The vehicle lamp according to claim 11, wherein the rear surface of the light guide of the vehicle decorative lighting device includes a concave shape toward the front surface of the light guide.
